(19) United States
(12) Patent Application Publication
(10) Pub. No.: US 2012/0252915 A1
(43) Pub. Date: Oct. 4, 2012

(54) TIRE FOR A VEHICLE HAVING A TREAD COMPRISING A HEAT-EXPANDABLE RUBBER COMPOSITION

(75) Inventors: Masayuki Maesaka, Ota-shi (JP); Salvatore Chiyoda-ku, Pagano (JP)

(73) Assignees: MICHELIN RECHERCHE ET TECHNIQUE S.A., Granges-Paccot (CH); CAMPAGNIE GENERALE DES ETABLISSEMENTS MICHELIN, Clermont-Ferrand (FR)

(21) Appl. No.: 13/511,262

(22) PCT Filed: Nov. 17, 2010
(86) PCT No.: PCT/EP2010/067669

§ 371 Date: Jun. 18, 2012

(30) Foreign Application Priority Data
Nov. 27, 2009 (FR) 0958432

(51) Int. Cl. C08L 9/00; C08L 7/00

(52) U.S. Cl. 521/95; 521/150; 521/140; 521/94

(57) ABSTRACT

A tyre is formed of a tread that includes, in the unvulcanized state, a heat-expandable rubber composition. The rubber composition includes at least a diene elastomer, 70 to 120 phr of a reinforcing filler, between 5 and 25 phr of a blowing agent, and between 5 and 25 phr of a thermofusible compound. The melting point of the thermofusible compound is between 70° C. and 150° C. and the total amount of the blowing agent and the thermofusible compound is greater than 15 phr. The rubber composition provides improved grip for the tread on melting ice.

### 1. FIELD OF THE INVENTION

The invention relates to rubber compositions which can be used as treads for pneumatic or non-pneumatic vehicle tyres, in particular “winter” pneumatic tyres capable of rolling over ground surfaces covered with ice or black ice without being provided with studs (also known as “studless” pneumatic tyres).

It relates more particularly to treads for winter pneumatic tyres specifically suited to rolling under “melting ice” conditions encountered within a temperature range typically of between −5° C. and 0° C. It should specifically be remembered that, within such a range, the pressure of the tyres during the passage of a vehicle brings about surface melting of the ice, which is covered with a thin film of water harmful to the grip of these pneumatic tyres.

### 2. BACKGROUND

In order to avoid the harmful effects of the studs, in particular their strong abrasive action on the surfacing of the ground surface itself and a significantly deteriorated road behaviour on a dry ground surface, pneumatic tyre manufacturers have provided various solutions which consist of modifying the formulation of the rubber compositions themselves.

Thus, a proposal has been made, first of all, to incorporate solid particles of high hardness, such as, for example, silicon carbide (see, for example U.S. Pat. No. 3,878,147), some of which will come to the surface of the tread as the latter wears and thus come into contact with the ice. Such particles, capable of acting in fact as micro-studs on hard ice, by virtue of a well-known “claw” effect, remain relatively aggressive with regard to the ground surface; they are not well suited to rolling conditions on melting ice.

Other solutions have thus been proposed which consist in particular in incorporating water-soluble powders in the composition forming the tread. Such powders dissolve more or less on contact with the snow or the melting ice, which makes possible, on the one hand, the creation, at the surface of the tread, of porosities capable of improving the grip of the tread on the ground surface and, on the other hand, the creation of grooves which act as channels for draining the liquid film created between the tyre and the ground surface. Mention may be made, as examples of such water-soluble powders, for example, of the use of cellulose powder, vinyl alcohol powder or starch powder, or else guar gum powder or xanthan gum powder (see for example, patent applications JP 3-159803, JP 2002-211203, EP 940 435, WO 2008/080750 and WO 2008/080751).

It has also been proposed to use powder particles that are neither of high hardness nor water-soluble, which are nevertheless capable of generating an effective surface microroughness (see in particular patent applications WO 2009/083125 and WO 2009/112220).

Finally, to improve the grip performance of a tread on ice, it is also well known to use a layer of foam rubber based on diene elastomer, an expansion agent (“blowing agent”) and various other additives. These blowing agents, such as for example nitro, sulphonyl or azo compounds, are capable, during a thermal activation, for example during the vulcanization of the pneumatic tyre, of releasing a large amount of gas, especially nitrogen, and thus of leading to the formation of bubbles within a sufficiently soft material such as a rubber composition comprising such blowing agents. Such foam rubber formulations for winter pneumatic tyres have been described for example in the patent documents JP 2003-183434, JP 2004-091747, JP 2006-299031, JP 2007-039499, JP 2007-314683, JP 2008-001826, JP 2008-150413, EP 826 522, U.S. Pat. No. 5,147,477 and U.S. Pat. No. 6,336,487.

### 3. BRIEF DESCRIPTION OF THE INVENTION

During their research into the above technology relating to the use of foam rubber, the applicants have discovered a specific rubber composition based on a high content of a blowing agent and a thermofusible compound combined, which makes it possible to greatly improve the grip of treads on melting ice.

Consequently, the present invention relates to a tyre, the tread of which comprises, in the unvulcanized state, a heat-expandable rubber composition comprising at least a diene elastomer, 70 to 120 phr of a reinforcing filler, between 5 and 25 phr of a blowing agent, between 5 and 25 phr of a thermofusible compound, the melting point of which is between 70° C. and 150° C., the total content of blowing agent and thermofusible compound being greater than 15 phr.

The invention also relates to a tyre in the vulcanized state obtained after curing (vulcanization) of the uncured tyre in accordance with the invention as described above.

The tyres of the invention are particularly intended to be fitted on motor vehicles of the passenger type, including 4×4 (four-wheel drive) vehicles and SUV vehicles (“Sport Utility Vehicles”), two-wheel vehicles (especially motorcycles), and also industrial vehicles chosen in particular from vans and heavy vehicles (i.e. underground trains, buses, heavy road transport vehicles such as lorries and tractor units).

The invention and its advantages will be readily understood in light of the description and exemplary embodiments that follow.

### 4. DETAILED DESCRIPTION OF THE INVENTION

In the present description, unless expressly indicated otherwise, all the percentages (%) indicated are % by weight. The abbreviation “phr” signifies parts by weight per hundred parts of elastomer (of the total of the elastomers if several elastomers are present).

Moreover, any interval of values denoted by the expression “between a and b” represents the range of values extending from more than “a” to less than “b” (i.e. limits a and b excluded) whereas any interval of values denoted by the expression “from a to b” means the range of values extending from “a” to “b” (i.e. including the strict limits a and b).

The tyre of the invention therefore has the essential feature that its tread, in the unvulcanized state, comprises a heat-expandable rubber composition at least for the upper part of the tread that comes directly into contact with the road surface, said composition comprising at least:
a (at least one) diene elastomer;
70 to 120 phr of a (at least one) reinforcing filler;
between 5 and 25 phr of a (at least one) blowing agent;
between 5 and 25 phr of a (at least one) thermofusible compound, the melting point of which is between 70° C. and 150° C.;
the total content of blowing agent and thermofusible compound being greater than 15 phr.

The various compounds above are described in detail hereinbelow.

### 4.1. Diene Elastomer

It is recalled that the term “elastomer” (or rubber, the two terms being synonymous) of the “diene” type should be understood to mean an elastomer resulting at least in part (i.e., a homopolymer or a copolymer) from diene monomers (monomers bearing two carbon-carbon double bonds which may or may not be conjugated).

Diene elastomers may be classified, in a known manner, into two categories: those said to be “essentially unsaturated” and those said to be “essentially saturated”. Butyl rubbers, and also for example diene/α-olefin copolymers of the EPDM type, fall under the category of essentially saturated diene elastomers, having a low or very low content of units of diene origin, always less than 15% (mol %). A contrario, the expression “essentially unsaturated diene elastomer” is understood to mean a diene elastomer resulting at least partly from conjugated diene monomers, having a content of units of diene origin (conjugated dienes) that is greater than 15% (mol %). In the “essentially unsaturated” diene elastomer category, the expression “highly unsaturated diene elastomer” is understood in particular to mean a diene elastomer having a content of units of diene origin (conjugated dienes) that is greater than 50%.

It is preferred to use at least one diene elastomer of the highly unsaturated type, in particular a diene elastomer selected from the group consisting of natural rubber (NR), synthetic poly-isoprenes (IRs), polybutadienes (BRs), butadiene copolymers, isoprene copolymers and mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs), and mixtures of such copolymers.

The elastomers can, for example, be block, random, sequential or microsequential elastomers and can be prepared in dispersion or in solution; they can be coupled and/or star-branched or else functionalized with a coupling and/or star-branching or functionalizing agent. For coupling with carbon black, mention may be made, for example, of functional groups comprising a C—Sn bond or of aminated functional groups, such as benzophenone, for example; for coupling with a reinforcing inorganic filler such as silica, mention may be made, for example, of silanol functional groups or polysiloxane functional groups having a silanol end (as described, for example, in U.S. Pat. No. 6,013,718), of alkoxysilane groups (as described, for example, in U.S. Pat. No. 5,977,238), of carboxylic groups (as described, for example, in U.S. Pat. No. 6,815,473 or US 2006/0089445) or else of polyether groups (as described, for example, in U.S. Pat. No. 6,503,973). Mention may also be made, as other examples of such functionalized elastomers, of the elastomers (such as SBR, BR, NR or IR) of the epoxidized type.

The following are preferably suitable: polybutadienes and in particular those having a content of 1,2- units of between 4% and 80% or those having a content of cis-1,4- units of greater than 80%, polyisoprenes, butadiene/styrene copolymers and in particular those having a styrene content of between 5% and 50% by weight and more particularly between 20% and 40%, a content of 1,2- bonds of the butadiene part of between 4% and 65% and a content of trans-1,4- bonds of between 20% and 80%, butadiene/isoprene copolymers and especially those having an isoprene content of between 5% and 90% by weight and a glass transition temperature (“T_{g}”, measured according to ASTM D3418-82) from −40° C. to −80° C., or isoprene/styrene copolymers and especially those having a styrene content of between 5% and 50% by weight and a T_{g} of between −25° C. and −50° C.

In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2- units of the butadiene part of between 4% and 85%, a content of trans-1,4- units of the butadiene part of between 6% and 80%, a content of 1,2- plus 3,4- units of the isoprene part of between 5% and 70% and a content of trans-1,4- units of the isoprene part of between 10% and 50%, and more generally any butadiene/styrene/isoprene copolymer having a T_{g} of between −20° C. and −70° C., are especially suitable.

According to a particularly preferred embodiment of the invention, the diene elastomer is selected from the group consisting of natural rubber, synthetic polyisoprenes, polybutadienes having a content of cis-1,4- bonds of greater than 90%, butadiene/styrene copolymers and mixtures of these elastomers.

According to a more particular and preferred embodiment, the heat-expandable rubber composition comprises 50 to 100 phr of natural rubber or of synthetic polyisoprene, it being possible for said natural rubber or synthetic polyisoprene to be used in particular as a blend (mixture) with at most 50 phr of a polybutadiene having a content of cis-1,4- bonds of greater than 90%.

According to another particular and preferred embodiment, the heat-expandable rubber composition comprises 50 to 100 phr of a polybutadiene having a content of cis-1,4- bonds of greater than 90%, it being possible for said polybutadiene to be used in particular as a blend with at most 50 phr of natural rubber or synthetic polyisoprene.

Synthetic elastomers other than diene elastomers, or even polymers other than elastomers, for example thermoplastic polymers, may be combined, in a minority amount, with the diene elastomers of the treads according to the invention.

### 4.2. Filler

Use may be made of any filler known for its capabilities of reinforcing a rubber composition, for example an organic filler such as carbon black, or an inorganic filler such as silica with which a coupling agent is combined in a known way.

Such a filler preferably consists of nanoparticles, the average size (by weight) of which is less than one micrometer, generally less than 500 nm, usually between 20 and 200 nm, in particular and more preferably between 20 and 150 nm.

The content of total reinforcing filler (in particular silica or carbon black or a mixture of silica and carbon black) is within a range of from 70 to 120 phr. A content greater than or equal to 70 phr is favourable to a good mechanical strength; above 120 phr there is a risk of excessive rigidity of the rubber layer. For these reasons, the content of total reinforcing filler is more preferably within a range of from 75 to 115 phr.

All carbon blacks, especially carbon blacks conventionally used in tyres (“tyre-grade” blacks) are for example suitable as carbon blacks, such as blacks of the 100, 200 or 300 series (ASTM grades), such as, for example, the N115, N134, N234, N326, N330, N339, N347 and N375 blacks. The carbon blacks could, for example, already be incorporated in the diene, especially isoprene, elastomer in the form of a masterbatch (see, for example, applications WO 97/36724 or WO 99/16600).

Mention may be made, as examples of organic fillers other than carbon blacks, of the functionalized polyvinyl organic fillers as described in applications WO-A-2006/069792, WO-A-2006/069793, WO-A-2008/003434 and WO-A-2008/003435.

The expression “reinforcing inorganic filler” should be understood here to mean any inorganic or mineral filler, whatever its colour and its (natural or synthetic) origin, also known as “white filler”, “clear filler” or sometimes “non-black filler”, in contrast to carbon black, capable of reinforcing by itself alone, without means other than an intermediate coupling agent, a rubber composition intended for the manufacture of pneumatic tyres, in other words capable of replacing, in its reinforcing role, a conventional tyre-grade carbon black; such a filler is generally characterized, in a known manner, by the presence of hydroxyl (—OH) groups at its surface.

Mineral fillers of the siliceous type, in particular silica (SiO₂), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g, in particular between 60 and 300 m²/g. Mention will be made, as highly dispersible precipitated silicas (“HDSs”), for example, of the “Ultrasil” 7000 and “Ultrasil” 7005 silicas from Degussa, the “Zeosil” 1165 MP, 1135 MP and 1115 MP silicas from Rhodia, the “Hi-Sil” EZ150G silica from PPG and the “Zeopol” 8715, 8745 and 8755 silicas from Huber.

According to another particularly preferred embodiment, use is made of a reinforcing inorganic filler, in particular silica, as the predominant filler, to which reinforcing inorganic filler carbon black may advantageously be added in a minority content at most equal to 15 phr, in particular within a range of from 1 to 10 phr.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is made in particular of silane polysulphides, referred to as “symmetrical” or “asymmetrical” depending on their specific structure, as described, for example, in applications WO 03/002648 (or US 2005/016651) and WO 03/002649 (or US 2005/016650).

Particularly suitable, without the definition below being limiting, are silane polysulphides corresponding to the following general formula (I):
(I) Z-A—Sₓ-A-Z, in which:
   x is an integer from 2 to 8 (preferably from 2 to 5);
   the A symbols, which are identical or different, represent a divalent hydrocarbon-based radical (preferably, a C₁-C₁₈ alkylene group or a C₆-C₁₂ arylene group, more particularly a C₁-C₁₀; especially C₁-C₄, alkylene, in particular propylene);
   the Z symbols, which are identical or different, correspond to one of the three formulae below:

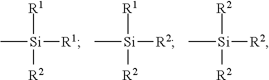

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, especially C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to formula (I) above, especially standard commercially-available mixtures, the average value of “x” is a fractional number preferably between 2 and 5, more preferably close to 4. But the invention may also be advantageously carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂HSO)₃Si(CH₂)₃S₂]₂ or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, as described in the aforementioned patent application WO 02/083782 (or U.S. Pat. No. 7,217,751).

Mention will especially be made, as examples of coupling agents other than an alkoxysilane polysulphide, of bifunctional POSs (polyorganosiloxanes) or else of hydroxysilane polysulphides (R²═OH in formula I above), such as described, for example, in patent applications WO 02/30939 (or U.S. Pat. No. 6,774,255), WO 02/31041 (or US 2004/051210) and WO 2007/061550, or else of silanes or POSs bearing azodicarbonyl functional groups, such as described, for example, in patent applications WO 2006/125532, WO 2006/125533 or WO 2006/125534.

As examples of other silane sulphides, mention will be made, for example, of the silanes bearing at least one thiol (—SH) function (referred to as mercaptosilanes) and/or at least one blocked thiol function, such as described, for example, in patents or patent applications U.S. Pat. No. 6,849,754, WO 99/09036, WO 2006/023815 or WO 2007/098080.

Of course, use could also be made of mixtures of the coupling agents described previously, as described in particular in the aforementioned application WO 2006/125534.

When they are reinforced by an inorganic filler such as silica, the rubber compositions preferably comprise between 2 and 15 phr, more preferably between 3 and 12 phr of coupling agent.

A person skilled in the art will understand that, as equivalent filler to the reinforcing inorganic filler described in the present section, a reinforcing filler of another nature, in particular organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

### 4.3. Blowing Agent and Associated Thermofusible Compound

As is known, a blowing agent is a thermally decomposable compound, intended to release, during a thermal activation, for example during the vulcanization of the pneumatic tyre, a large amount of gas and to thus lead to the formation of bubbles. The release of gas into the rubber composition therefore originates from this thermal decomposition of the blowing agent. In most cases, the gas formed is nitrogen, but it may also be, depending on the nature of the blowing agent used, that this gas contains carbon dioxide.

There are physical or chemical blowing agents, of endothermic or exothermic type. Use is preferably made of chemical blowing agents, more preferably of chemical blowing agents of exothermic type.

Among the blowing agents that can preferably be used, mention will especially be made of those selected from the group consisting of azo, nitroso, hydrazine, carbazide, semicarbazide, tetrazole, carbonate, citrate compounds, and mixtures of such compounds.

These blowing agents are more preferably selected from the group consisting of diazo, dinitroso, sulphonyl semicarbazide, sulphonyl hydrazide compounds, and mixtures of such compounds. Among the latter, mention may more particularly be made of dinitroso-pentane-ethylene tetramine, dinitroso-pentane-styrene tetramine, azodicarbonamide, N,N′-dimethyl-N,N′-dinitrosophthalamide, benzenesulphonyl hydrazide, toluenesulphonyl hydrazide, p,p′-oxybis(benzenesulphonyl hydrazide), p-toluenesulphonyl semicarbazide or else p,p′-oxybis(benzenesulphonyl semicarbazide); in these examples, the gas formed is composed of a mixture of nitrogen and carbon dioxide.

Among the blowing agents that release only carbon dioxide, mention may be made, for example, of the following compounds: alkali and alkaline-earth metal carbonates and bicarbonates, such as sodium carbonate or bicarbonate, ammonium carbonate or bicarbonate, citrates such as sodium monocitrate, malonic acid and citric acid.

Preferably, the content of blowing agent is between 8 and 20 phr.

One essential feature of the invention is adding a thermofusible compound, the melting point of which is between 70° C. and 150° C., preferably between 100° C. and 150° C., more preferably between 110° C. and 140° C., to the blowing agent described above. The melting point is a well-known base physical constant (available for example in “Handbook of Chemistry and Physics”) of organic or inorganic thermofusible compounds; it could be verified by any known method, for example by the Thiele method, the Kofler bench method or else by DSC.

The content of this thermofusible compound is preferably between 8 and 20 phr. It has the role of being converted to liquid in the specific temperature range indicated above, before or at the moment when the blowing agent thermally decomposes and releases bubbles of gas.

Any compound having a melting point between 70° C. and 150° C., preferably between 100° C. and 150° C., more preferably between 110° C. and 140° C., is likely to be suitable. Use will especially be able to be made of the rubber additives known to those skilled in the art as being compatible, both as regards their form (for example in powder form) and their chemical nature, with standard rubber compositions for pneumatic tyres.

By way of example, mention may especially be made of thermoplastic polymers such as polyethylene or polypropylene.

Mention may also be made, as examples of thermoplastic hydrocarbon-based resins having a high glass transition temperature (T_{g}), the melting point (or what is here considered to be equivalent, the softening point, measured for example according to the known “Ring and Ball” method—standard ISO 4625) of which is between 70° C. and 150° C., preferably between 100 and 150° C., more preferably between 110° C. and 140° C.

The term “resin” is reserved in the present application, by definition, as known to those skilled in the art, to a compound which is solid at room temperature (23° C.), as opposed to a liquid plasticizer compound such as an oil.

These hydrocarbon-based resins are polymers well known to those skilled in the art, essentially based on carbon and hydrogen, which can be used in particular as plasticizing agents or tackifiers in polymeric matrices. They may be aliphatic, cycloaliphatic, aromatic, hydrogenated aromatic, of the aliphatic/aromatic type, i.e. based on aliphatic and/or aromatic monomers. They may be natural or synthetic resins, whether or not based on petroleum (if such is the case, they are also known as petroleum resins). Such thermoplastic hydrocarbon-based resins may be selected, for example, from the group consisting of cyclopentadiene homopolymer or copolymer resins, dicyclopentadiene homopolymer or copolymer resins, terpene homopolymer or copolymer resins, terpene-phenol homopolymer or copolymer resins, C₅-cut homopolymer or copolymer resins, C₉-cut homopolymer or copolymer resins, α-methylstyrene homopolymer or copolymer resins and mixtures of these resins.

According to one particularly preferred embodiment, the thermofusible compound selected is urea or a thermofusible derivative of urea. Urea in particular has a melting point that is well suited to the targeted application.

An essential feature of the invention, for obtaining an optimized grip of the tread on melting ice, is that the total amount of blowing agent and of thermofusible compound is greater than 15 phr, preferably between 15 and 40 phr. This total amount is more preferably greater than 20 phr, in particular between 20 and 40 phr, especially between 20 and 35 phr.

### 4.4. Various Additives

The heat-expandable rubber composition may also comprise all or some of the usual additives customarily used in the rubber compositions for treads of pneumatic tyres, such as, for example, protective agents such as antiozone waxes, chemical antiozonants, antioxidants, plasticizing agents, reinforcing resins, a crosslinking system based either on sulphur or on donors of sulphur and/or peroxide and/or bismaleimides, vulcanization accelerators, or vulcanization activators.

According to one preferred embodiment, the heat-expandable rubber composition also comprises a plasticizing agent that is liquid (at 20° C.), the role of which is to soften the matrix by diluting the diene elastomer and the reinforcing filler; its T_{g} (glass transition temperature) is by definition less than −20° C., preferably less than −40° C.

More preferably, for an optimum performance of the tyre tread of the invention, this liquid plasticizer is used at a relatively low content, such that the weight ratio of reinforcing filler to liquid plasticizing agent is greater than 2.0, more preferably greater than 2.5, in particular greater than 3.0.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances that have the ability to eventually take on the shape of their container), as opposed, in particular, to plasticizing hydrocarbon-based resins which are by nature solid at ambient temperature.

Liquid plasticizers selected from the group consisting of naphthenic oils (low or high viscosity, in particular hydrogenated or not), paraffinic oils, MES (Medium Extracted Solvates) oils, TDAE (Treated Distillate Aromatic Extracts) oils, mineral oils, plant oils, ether plasticizers, ester plasticizers, phosphate plasticizers, sulphonate plasticizers and mixtures of these compounds are particularly suitable.

Mention may be made, as phosphate plasticizers for example, of those that contain between 12 and 30 carbon atoms, for example trioctyl phosphate. As examples of ester plasticizers, mention may especially be made of the compounds selected from the group consisting of trimellitates, pyromellitates, phthalates, 1,2-cyclohexane dicarboxylates, adipates, azelates, sebacates, triesters of glycerol, and mixtures of these compounds. Among the above triesters, mention may especially be made of glycerol triesters, preferably composed predominantly (for more than 50% by weight, more preferably for more than 80% by weight) of an unsaturated C₁₈ fatty acid, that is to say an unsaturated fatty acid selected from the group consisting of oleic acid, linoleic acid, linolenic acid and mixtures of these acids. More preferably, whether of synthetic origin or natural origin (in the case, for example, of sunflower or rapeseed vegetable oils), the fatty acid used is composed for more than 50% by weight, more preferably still for more than 80% by weight, of oleic acid. Such triesters (trioleates) comprising a high content of oleic acid are well known; for example they have been described in application WO 02/088238, as plasticizing agents in treads for pneumatic tyres.

The heat-expandable rubber composition may also contain coupling activators when a coupling agent is used, agents for covering the inorganic filler when an inorganic filler is used, or more generally processing aids capable, in a known manner, owing to an improvement of the dispersion of the filler in the rubber matrix and to a lowering of the viscosity of the compositions, of improving their ability to be processed in the uncured state; these agents are, for example, hydrolysable silanes or hydroxysilanes such as alkylalkoxysilanes, polyols, polyethers, amines or hydroxylated or hydrolysable polyorganosiloxanes.

### 4.5. Manufacture of the Compositions

The rubber compositions are manufactured in appropriate mixers using, for example, three successive preparation phases according to a general procedure well known to a person skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second (non-productive) phase at a lower temperature (preferably below 100° C.) during which the blowing agent is incorporated, and finally a third phase of mechanical working (sometimes referred to as a “productive” phase) at low temperature, typically below 120° C., for example between 60° C. and 100° C., finishing phase during which the crosslinking or vulcanization system is incorporated.

A process that can be used for the manufacture of such rubber compositions comprises, for example, and preferably, the following stages:
in a mixer, incorporating into the elastomer or into the mixture of elastomers, at least the filler and the thermofusible compound, everything being kneaded thermomechanically, in one or more steps, until a maximum temperature of between 130° C. and 200° C. is reached;
cooling the combined mixture to a temperature below 100° C.;
then incorporating the blowing agent into the mixture thus obtained and cooled, everything being kneaded thermomechanically until a maximum temperature of below 100° C. is reached;
subsequently incorporating a crosslinking system;
kneading everything up to a maximum temperature below 120° C.;
extruding or calendering the rubber composition thus obtained.

By way of example, during the first non-productive phase all the necessary constituents, the optional additional covering agents or processing aids, and other various additives, with the exception of the blowing agent and the crosslinking system, are introduced into an appropriate mixer, such as a standard internal mixer. After thermomechanical working, dropping and cooling of the mixture thus obtained, a second (non-productive) phase of thermomechanical working is then carried out in the same internal mixer, during which phase the blowing agent is incorporated at a more moderate temperature (for example 60° C.), in order to attain a maximum dropping temperature of less than 100° C. The crosslinking system is then incorporated, at low temperature, generally in an external mixer, such as an open mill. The combined mixture is then mixed (productive phase) for a few minutes, for example between 5 and 15 min.

The crosslinking system itself is preferably based on sulphur and on a primary vulcanization accelerator, in particular an accelerator of the sulphenamide type. Added to this vulcanization system are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 5 phr and the primary accelerator content is preferably between 0.5 and 8 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are for example selected from the group consisting of 2-mercaptobenzothiazyl disulphide (abbreviated to “MBTS”), tetrabenzylthiuram disulphide (“TBZTD”), N-cyclohexyl-2-benzothiazyl sulphenamide (“CBS”), N,N-dicyclohexyl-2-benzothiazyl sulphenamide (“DCBS”), N-tert-butyl-2-benzothiazyl sulphenamide (“TBBS”), N-tert-butyl-2-benzothiazyl sulphenimide (“TBSI”), zinc dibenzyldithiocarbamate (“ZBEC”) and the mixtures of these compounds.

The final composition thus obtained is then calendered, for example in the form of a sheet or a slab, in particular for laboratory characterization, or else is calendered or extruded in the form of a heat-expandable tread.

In the uncured (i.e. unvulcanized) state and therefore non-expanded state, the density or specific gravity, denoted by D₁, of the heat-expandable rubber composition is preferably between 1.100 and 1.400 g/cm³, more preferably within a range of from 1.150 to 1.350 g/cm³.

The vulcanization (or curing) is carried out, in a known manner, at a temperature generally between 130° C. and 200° C., for a sufficient time that may vary, for example, between 5 and 90 min depending in particular on the curing temperature, on the vulcanization system used and on the vulcanization kinetics of the composition in question.

It is during this vulcanization step that the blowing agent will release a large amount of gas, leading to the formation of bubbles in the foam rubber composition and finally to its expansion.

In the cured (i.e. vulcanized) state, the density, denoted by D₂, of the rubber composition once it is expanded (i.e. in the foam rubber state) is preferably between 0.700 and 1.000 g/cm³, more preferably within a range of from 0.750 to 0.950 g/cm³.

Its volume expansion ratio, denoted by T_{E} (expressed in %) is preferably between 25% and 75%, more preferably within a range of from 30% to 60%, this expansion ratio T_{E} being calculated in a known manner from the densities D₁ and D₂ above, as follows:

T_{E}=[(D₁/D₂)−1]×100.

### 5. EXEMPLARY EMBODIMENTS OF THE INVENTION

The heat-expandable rubber composition described previously can advantageously be used in the treads of winter pneumatic tyres for any type of vehicle, in particular in pneumatic tyres for passenger vehicles, as demonstrated in the following tests.

For the requirements of these tests, two rubber compositions (denoted by C-0 and C-1) were prepared, the formulation of which is given in Table 1 (content of the various products expressed in phr). Composition C-0 is the control composition, composition C-1 is that in accordance with the invention, additionally comprising the blowing agent and the thermofusible compound. The content of liquid plasticizer was adjusted in composition C-1 to in order to maintain the rigidity, after curing, at the same level as that of the control composition C-0 (Shore A hardness equal to around 51 in both cases, measured in accordance with the standard ASTM D 2240-86).

The manufacture of these compositions was carried out in the following manner: the reinforcing filler (silica), the diene elastomer (blend of NR and BR), the thermofusible compound (urea) for composition C-1, and also the various other ingredients, with the exception of the vulcanization system and the blowing agent, were successively introduced into an internal mixer, the initial vessel temperature of which was around 60° C.; the mixer was thus filled to around 70% (% by volume). Thermomechanical working (non-productive phase) was then carried out in one stage of around 2 to 4 min, until a maximum “dropping” temperature of around 150° C. was reached. The mixture thus obtained was then cooled to a temperature below 100° C., the cooled mixture was reintroduced into the same internal mixer (initial temperature 60° C.), then, for composition C-1, the blowing agent (diazo compound) was incorporated into said mixture (mixer filled to around 70% by volume). A second thermomechanical working (non-productive phase) was then carried out in one stage of around 2 to 4 min, until a maximum “dropping” temperature below 100° C. was reached. The mixture thus obtained was recovered and cooled and then an accelerator of sulphenamide type and sulphur were incorporated in an external mixer (homofinisher) at 30° C., the combined mixture being mixed (productive phase) for a few minutes.

The compositions C-0 and C-1 thus prepared were then used as treads for radial carcass passenger vehicle winter pneumatic tyres, denoted respectively by T-0 (control tyres) and T-1 (tyres in accordance with the invention), with a size of 205/65 R15 conventionally manufactured and in all respects identical apart from the rubber compositions forming their tread.

Table 2 indicates the properties measured before and after curing: for an equivalent Shore hardness, the tread of the pneumatic tyre in accordance with the invention has after curing, once in the foam rubber (i.e. expanded) state, a significantly reduced density corresponding to a particularly high volume expansion ratio of around 47%.

The T-0 and T-1 tyres are fitted, under nominal tyre pressure, to the front and rear of a motor vehicle (“Honda Civic”) equipped with an anti-lock braking system (ABS system) and with an anti-slipping system during acceleration (TCS system for traction control system). The distance necessary to change from 20 to 5 km/h during sudden longitudinal braking (ABS activated) on a track covered with ice, maintained at a temperature of −2° C. (“melting ice” conditions) is measured.

After this first series of tests on new pneumatic tyres, these tyres were subjected to running on a circuit of around 10 000 km, on a dry ground surface, for the beginning of wear. Next, the partially worn tyres are again subjected to the tests of grip on ice as described above.

All of the results of the running tests are reported in Table 3, in relative units, the base 100 being selected for the control tyre T-0. A value greater than that of the control, arbitrarily set at 100, indicates an improved result, i.e. a shorter braking distance.

It is noted that although an improvement (6%) is already observed on the new pneumatic tyre, the braking distance on melting ice is increased remarkably and unexpectedly by almost 50% relative to the control pneumatic tyre, after running for 10 000 km.

This result very clearly illustrates the capacity of the foam rubber composition, once vulcanized (expanded), to generate throughout the use of the pneumatic tyre of the invention, a particularly effective and significant surface microroughness, owing to the combined use of a blowing agent and a thermofusible compound, at the recommended high contents.

TABLE 1

Composition No.:

| | C-0 | C-1 |
|---|---|---|
| BR (1) | 60 | 60 |
| NR (2) | 40 | 40 |
| silica (3) | 80 | 80 |
| coupling agent (4) | 5 | 5 |
| carbon black (5) | 5 | 5 |
| blowing agent (6) | | 13.5 |
| thermofusible compound (7) | | 13.5 |
| liquid plasticizer (8) | 60 | 20 |
| DPG (9) | 1.5 | 1.5 |
| ZnO | 1.2 | 1.2 |
| stearic acid | 1 | 1 |
| antiozone wax | 1.5 | 1.5 |
| antioxidant (10) | 2 | 2 |
| sulphur | 2 | 2 |
| accelerator (11) | 1.7 | 1.7 |

(1) BR with 4.3% of 1,2-units; 2.7% of trans units; 97% of cis-1,4 units (T_{g} = −104° C.);
(2) natural rubber (peptised);
(3) silica “Ultrasil 7000” from Degussa, “HDS” type (BET and CTAB: around 160 m²/g);
(4) coupling agent TESPT (“Si69” from Degussa);
(5) ASTM grade N234 (Cabot);
(6) azodicarbonamide (“Cellmic C-22” from Sankyo Kasei);
(7) urea (Mitsui Chemical);
(8) MES oil (“Catenex SNR” from Shell);
(9) diphenylguanidine (Perkacit DPG from Flexsys);
(10) N-1,3-dimethylbutyl-N-phenyl-para-phenylenediamine (Santoflex 6-PPD from Flexsys);
(11) N-dicyclohexyl-2-benzothiazole sulphenamide (“Santocure CBS” from Flexsys).

TABLE 2

Composition tested:

| | C-0 | C-1 |
|---|---|---|
| Shore A hardness | 52 | 50 |
| Density before curing of the tyre | 1.14 | 1.21 |
| Density after curing of the tyre | 1.14 | 0.82 |
| Volume expansion ratio (%) | 0 | 47 |

TABLE 3

Pneumatic tyre tested:

| | T-0 | T-1 |
|---|---|---|
| Braking on ice (−2° C.)⁽¹⁾ | 100 | 106 |
| Braking on ice (−2° C.)⁽²⁾ | 100 | 143 |

⁽¹⁾ new pneumatic tyre
⁽²⁾ partially worn pneumatic tyre

1.-21. (canceled)

22. A tyre including a tread, wherein the tread comprises, in an unvulcanized state, a heat-expandable rubber composition that includes at least:
a diene elastomer;
70 to 120 phr of a reinforcing filler;
between 5 and 25 phr of a blowing agent; and
between 5 and 25 phr of a thermofusible compound,
wherein a melting point of the thermofusible compound is between 70° C. and 150° C., and
wherein a total amount of the blowing agent and the thermofusible compound is greater than 15 phr.

23. The tyre of claim 22, wherein the diene elastomer is selected from the group consisting of a natural rubber, synthetic polyisoprenes, polybutadienes, butadiene copolymers, isoprene copolymers, and mixtures thereof.

24. The tyre of claim 23, wherein the rubber composition includes 50 to 100 phr of the natural rubber or a synthetic polyisoprene.

25. The tyre of claim 24, wherein the natural rubber or the synthetic polyisoprene is included as a blend with at most 50 phr of a polybutadiene having greater than 90% of cis-1,4 bonds.

26. The tyre of claim 23, wherein the rubber composition includes 50 to 100 phr of a polybutadiene having greater than 90% of cis-1,4 bonds.

27. The tyre of claim 26, wherein the polybutadiene is included as a blend with at most 50 phr of the natural rubber or a synthetic polyisoprene.

28. The tyre of claim 22, wherein the reinforcing filler includes an inorganic filler, carbon black, or a mixture of an inorganic filler and carbon black.

29. The tyre of claim 22, wherein the rubber composition is within a range of from 75 to 115 phr of the reinforcing filler.

30. The tyre of claim 22, wherein the rubber composition further includes a plasticizing agent that is a liquid at 20° C., the plasticizing agent being present in an amount such that a weight ratio of the reinforcing filler to the plasticizing agent is greater than 2.0.

31. The tyre of claim 22, wherein the blowing agent is selected from the group consisting of azo compounds, nitroso compounds, hydrazine compounds, carbazide compounds, semicarbazide compounds, tetrazole compounds, carbonate compounds, citrate compounds, and mixtures thereof.

32. The tyre of claim 31, wherein the blowing agent is selected from the group consisting of diazo compounds, dinitroso compounds, sulphonyl semicarbazide compounds, sulphonyl hydrazide compounds, and mixtures thereof.

33. The tyre of claim 31, wherein the blowing agent is an azodicarbonamide compound.

34. The tyre of claim 22, wherein the rubber composition is between 8 and 20 phr of the blowing agent.

35. The tyre of claim 22, wherein the rubber composition is between 8 and 20 phr of the thermofusible compound.

36. The tyre of claim 22, wherein the total amount of the blowing agent and the thermofusible compound is greater than 20 phr.

37. The tyre of claim 22, wherein the melting point of the thermofusible compound is between 100° C. and 150° C.

38. The tyre of claim 22, wherein the thermofusible compound is urea or a thermofusible derivative of urea.

39. The tyre of claim 22, wherein a density of the rubber composition is between 1.100 and 1.400 g/cm³.

40. The tyre of claim 22, wherein the tyre is cured to a vulcanized state.

41. The tyre of claim 40, wherein a density of the rubber composition after expansion from curing is between 0.700 and 1.000 g/cm³.

42. The tyre of claim 40 or 41, wherein a volume expansion ratio of the rubber composition after expansion from curing is between 25% and 75%.
